(19) United States
(12) Patent Application Publication
(10) Pub. No.: US 2026/0149200 A1
(43) Pub. Date: May 28, 2026

(54) CABLE CARD ASSEMBLY INCLUDING PLURAL BUNKERS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: JIM ZHAO, Irvine, CA (US); Terrance F. Little, Fullerton, CA (US); Yuhtseng Chew, Rowland Heights, CA (US)

(21) Appl. No.: 19/016,505

(22) Filed: Jan. 10, 2025

Related U.S. Application Data
(60) Provisional application No. 63/726,208, filed on Nov. 27, 2024.

(51) Int. Cl. H01R 12/53; H01R 12/72; H01R 13/6471; H01R 13/6592

(52) U.S. Cl. CPC H01R 12/53; H01R 12/728; H01R 13/6471; H01R 13/6592

(57) ABSTRACT

A cable card assembly includes: a paddle card having plural mating pads at a front end thereof, plural cable pads and ground pads at a rear end thereof; plural cables terminated to the paddle card at the rear end, each cable having two signal conductors terminated to corresponding cable pads and a ground shield; and plural bunkers terminated to corresponding ground pads, each bunker having a front opening, a bottom wall, a pair of side walls, a rear wall, and a top wall.

### CROSS REFERENCE TO RELATED APPLICATION

This application claims priority to and benefit of U.S. Provisional Ser. No. 63/726,208 , filed Nov. 27, 2024.

### BACKGROUND OF THE INVENTION

### 1. Field of the Invention

The present invention relates to a cable card assembly comprising a paddle card having plural mating pads at a front end thereof, plural cable pads and ground pads at a rear end thereof, plural cables terminated to the paddle card at the rear end, each cable having two signal conductors terminated to corresponding cable pads and a ground shield, and plural bunkers terminated to corresponding ground pads, each bunker having a front opening and plural walls for reducing cross-talk on high-speed cable paddle card and cable termination areas.

### 2. Description of Related Arts

As “AI driven” data center high speed infrastructure develops, the transmission rate required is getting higher and higher.

U.S. Pat. No. 8,840,432 discloses a cable card assembly including plural ground shields each having a pair of side segments, an upper segment, and an end segment.

U.S. Pat. No. 9,640,880 discloses a cable card assembly including a shielding structure having a cap and plural sidewalls extending from the cap.

U.S. Pat. No. 12,003,061 discloses a cable card assembly including a molded conductive ground bus having opposite first and second sides, an outer wall therebetween, and separating walls extending from the outer wall.

### SUMMARY OF THE INVENTION

A cable card assembly comprises: a paddle card having plural mating pads at a front end thereof, plural cable pads and ground pads at a rear end thereof; plural cables terminated to the paddle card at the rear end, each cable having two signal conductors terminated to corresponding cable pads and a ground shield; and plural bunkers terminated to corresponding ground pads, each bunker having a front opening, a bottom wall, a pair of side walls, a rear wall, and a top wall.

The bunker has not only the pair of side walls, the rear wall, and the top wall, but also the bottom wall in order to achieve a better shielding effect.

### BRIEF DESCRIPTION OF DRAWINGS

FIG. 1 is a perspective view of a cable card assembly in accordance with the present invention;

FIG. 2 is a view similar to FIG. 1 but showing a bunker structure of the cable card assembly at a state prior to its final state;

FIG. 3 is a top plan view of the cable card assembly;

FIG. 4 is a view similar to FIG. 2 but with cables of the cable card assembly removed;

FIG. 5 is an exploded view of FIG. 4;

FIG. 6 shows an unfolded flat blank of sheet metal for forming the bunker structure;

FIG. 7 is a perspective view of a varied cable card assembly in accordance with the present invention;

FIG. 8 is a view similar to FIG. 7 but showing a varied bunker structure of the varied cable card assembly is processed to its final state;

FIG. 9 is a top plan view of the varied cable card assembly;

FIG. 10 shows the varied bunker structure with a pickup and place tool;

FIG. 11 is a view similar to FIG. 8 but with cables of the varied cable card assembly removed;

FIG. 12 is a perspective view of a bunker of the varied bunker structure at the state in FIG. 8;

FIG. 13 is a cross-sectional view of a cable similar to FIG. 12 but showing the bunker at another state;

FIG. 14 is a cross-sectional view of an exemplary cable;

FIG. 15 is a perspective view of another varied cable card assembly in accordance with the present invention;

FIG. 16 is a perspective view of another varied bunker structure;

FIG. 17 is another perspective view of the varied bunker structure in FIG. 16;

FIG. 18 is an exploded view of FIG. 16; and

FIG. 19 is an exploded view of FIG. 17.

### DETAILED DESCRIPTION OF THE DRAWINGS

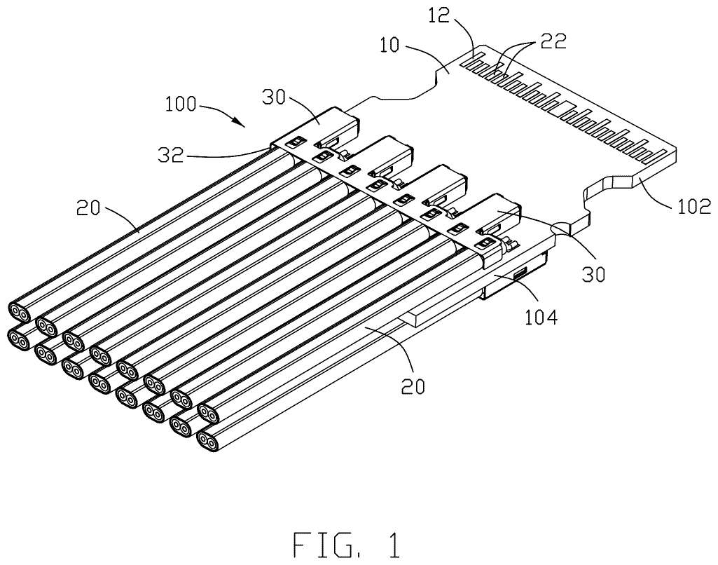

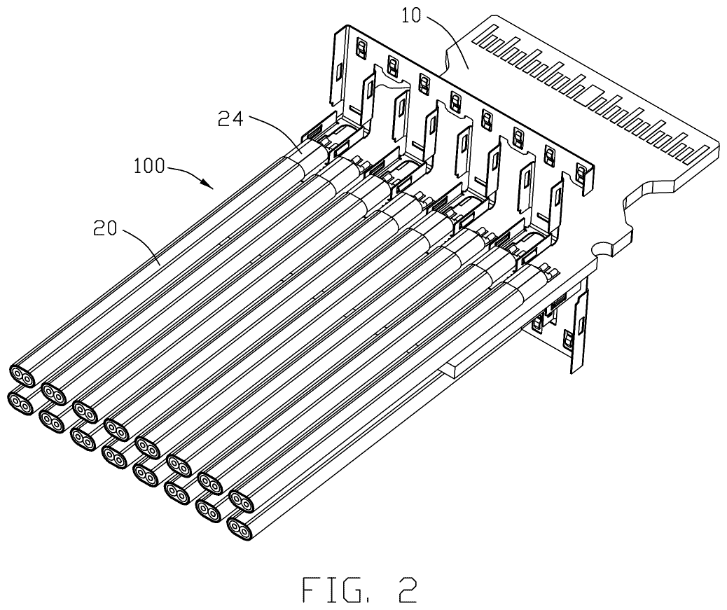

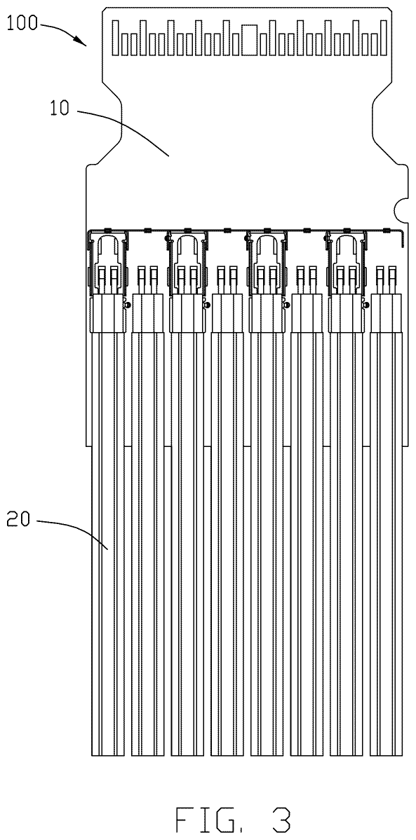

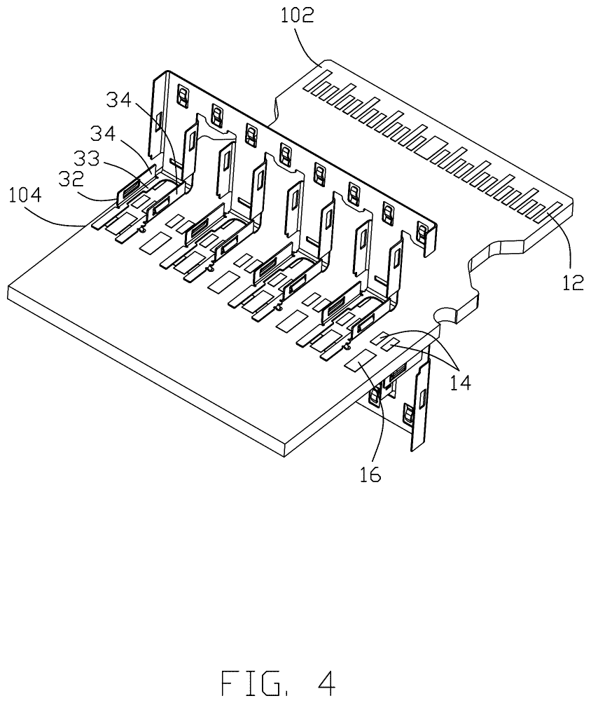

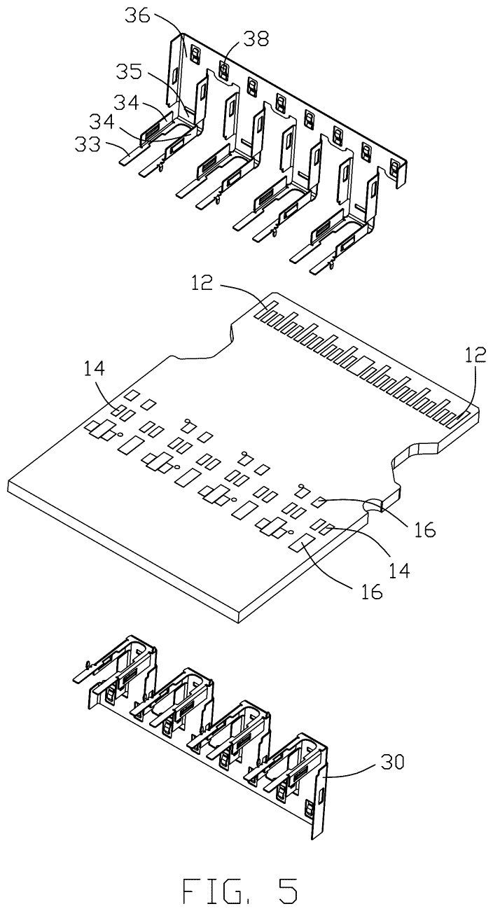

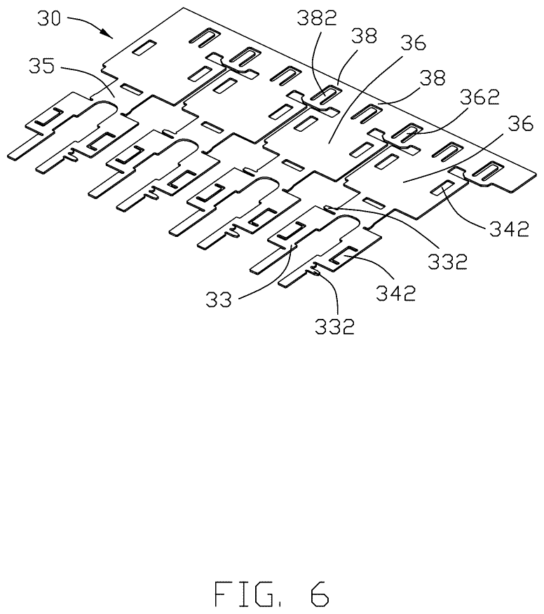

Referring to FIGS. 1-6, a cable card assembly 100 comprises: a paddle card 10 having plural mating pads 12 at a front end 102 thereof, plural cable pads 14 and ground pads 16 at a rear end 104 thereof, plural cables 20 terminated to the paddle card 10 at the rear end 104, each cable 20 having two signal conductors 22 terminated to corresponding cable pads 14 and a ground shield 24; and plural bunkers 30 terminated to corresponding ground pads 16, for reduce crosstalk at the connection between the cable 20 and the paddle card 10. The cable 20 is a drainless twin-ax cable. Each bunker 30 having a front opening 32, a bottom wall 33, a pair of side walls 34, a rear wall 35, and a top wall 36. The bunker 30 is a metal cage formed by the walls. The cables 20 are terminated on the paddle card 10 in a single row. The bunker 30 allows “pair to pair” signal conductors 22 shielding of the of the cable 20 in a single row. The side walls automatically shield the pairs of the signal conductors 22 of two adjacent cables 20. As is well known, the paddle card assembly may be implemented in a pluggable module. Also well known is that the front mating pads 12 are electrically connected through wiring traces in the paddle card 10 to the rear cable pads 14 and ground pads 16. The bunker 30 has not only the bottom wall 33 but also the rear wall 35 in order to achieve a better shielding effect.

The bunkers 30 may be formed from an unfolded flat blank of sheet metal which is conveniently manufactured from ordinary stamping operation. Features 332 may be formed on the bottom wall 33 for positioning the bunker 30 to the paddle card 10. The features 332 are pins or posts extending downwardly, and the paddle card 10 has corresponding holes for the pins or the posts to pass through. Latching features 342 may also be formed on the side wall 34 in order to assist in formation of the side wall 34 itself. The latching features 342 are resilient fingers stamped from the side walls 34. Respective top walls 36 of the bunkers 30 may be connected together by linking portions 38 between the top walls 36 of every two adjacent bunkers 30. The top wall 36 has a feature 362 for engaging the ground shield 24 of the cable 20. The feature 362 is an elastic finger. After the top wall 36 is closed, the feature 362 abuts the ground shield 24 of the corresponding cable 20. Solder may also be applied to the contact area of the feature 362 and the ground shield 24. The linking portion 38 may similarly have a feature 382 for engaging the ground shield 24 of a cable which is not enclosed by all the walls of a bunker. The cable 20 is assembled inside the bunker 30. The cable 20 is resistance welded or laser soldered to the paddle card 10. The bunkers 30 are installed on both sides of the paddle card 10. The bunkers 30 may be suitably arranged in a belly to belly manner.

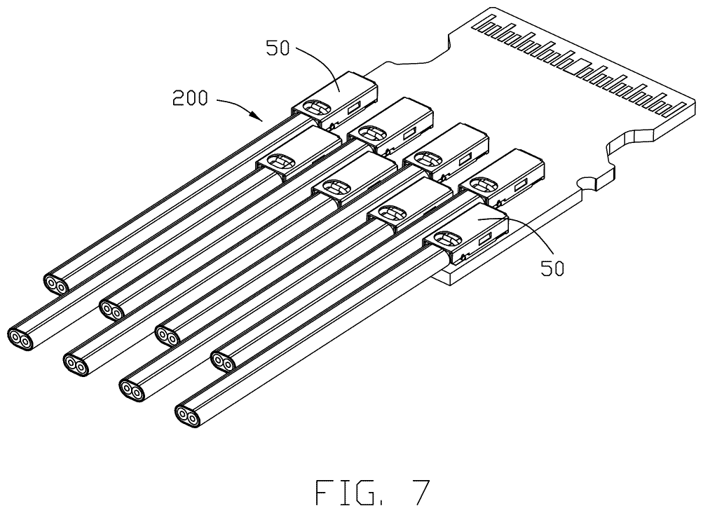

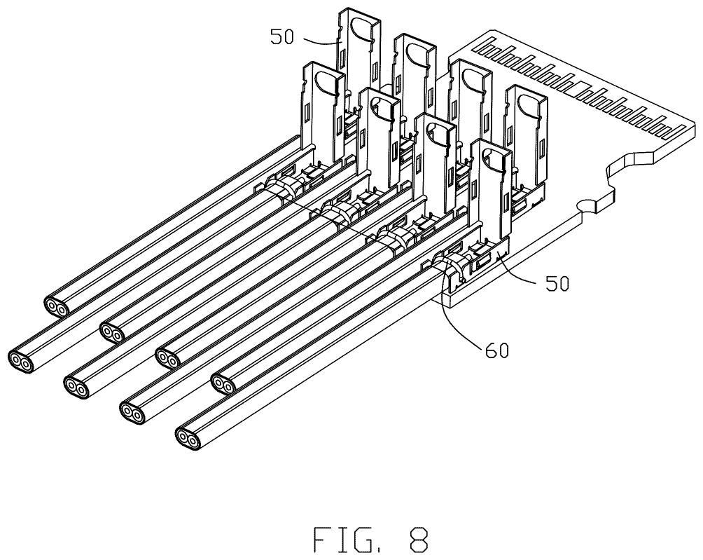

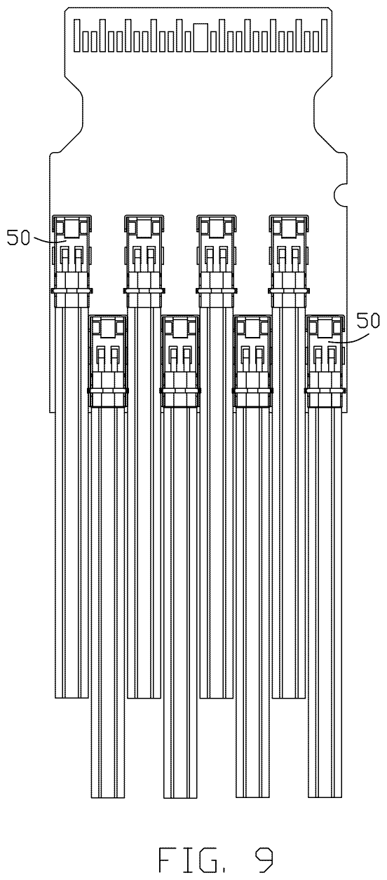

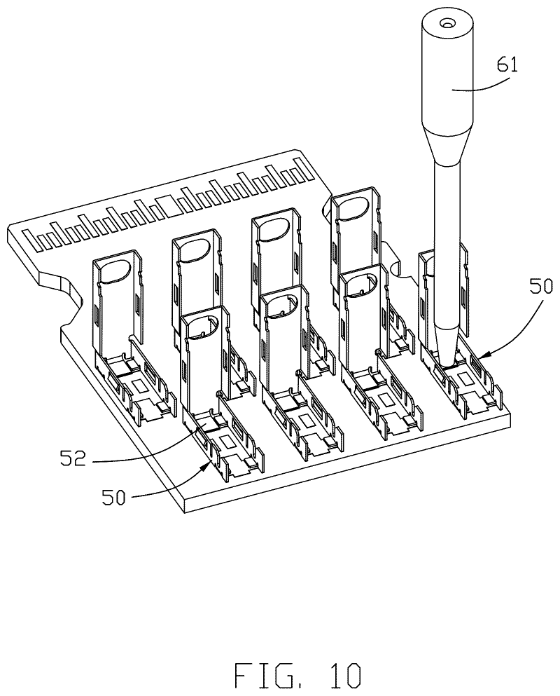

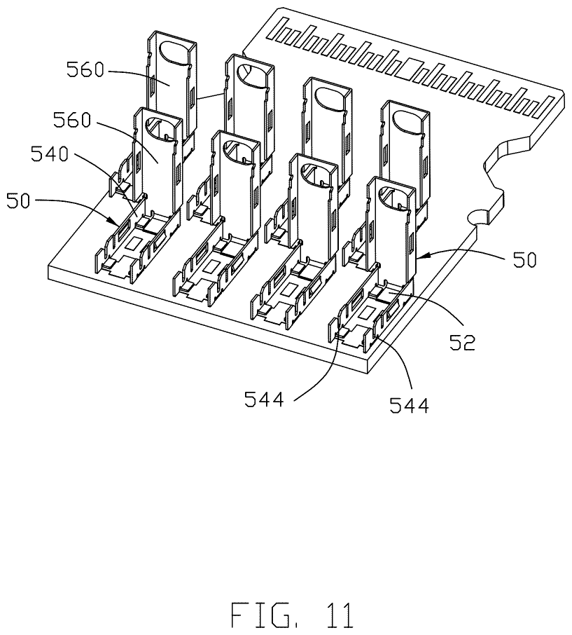

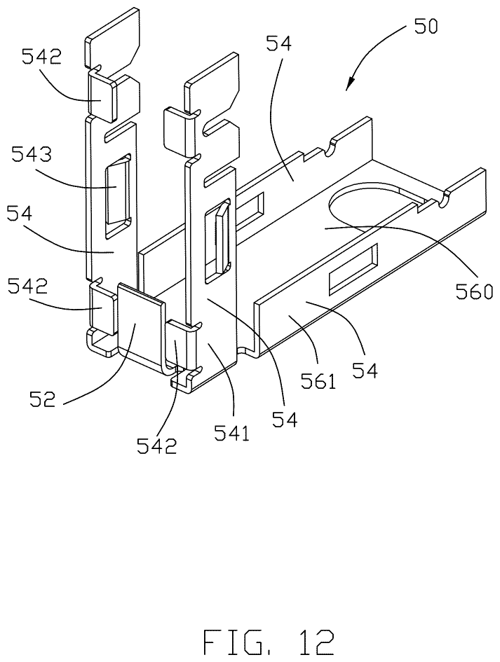

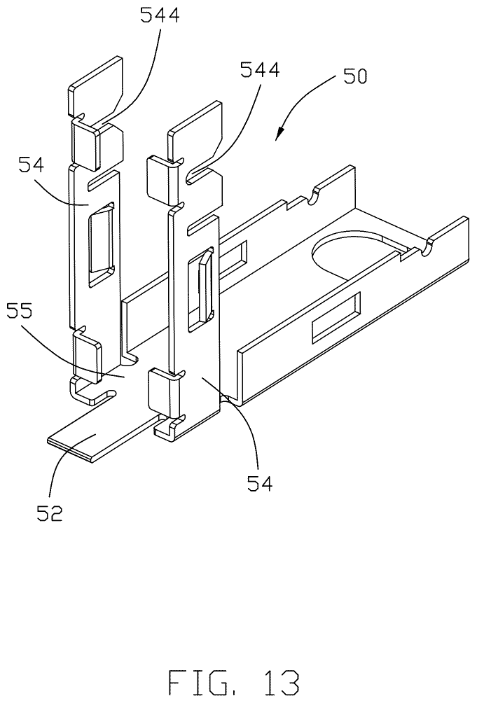

FIGS. 7-13 show a varied cable card assembly 200 which differs from the assembly 100 primarily in that plural bunkers 50 thereof are each separate and discrete rather than connected together by linking portions. The bunker 50 includes a cage body 540 and a cage cover 560. The cage body 540 is installed on the circuit board, and the cage cover 560 is fastened to the cage body 540. Both the cage cover 560 and the cage body 540 have a pair of side walls 54. The cage cover 560 has a pair of side walls 561, and the cage body 540 has a pair of side walls 541. The side walls 561 are located outside the corresponding side walls 541. In this design, for ease of placing each individual bunker 50 onto the paddle card, a flat flap 52 is formed on the bunker 50, preferably extending from a rear wall 55 thereof, for being operated by a pickup and place tool 61. Also seen are features 542 bent from side walls 54 of the cage body 540 of the bunker 50 for terminating to ground pads 16 on the paddle card. As another way of engaging the bunker 50 to the ground shield 24 of the cable, a wire 60 is provided for fitting into a respective cut 544 formed on the side wall 54. The cables are terminated on the paddle card in a staggered fashion in a front and rear direction.

The bunker 50 can be blanked from a copper alloy, such as Phos. Bronze C-5210. The flat flaps 52 of the plural bunkers 50 are initially connected by carrier strip. After blanking, latching features 543 of the cage body 540 will be formed. The next step is to form up the SMT solder feet features 542 on the cage body 540. The next step is to form up the side walls 541 of the cage body 540. The next step is to form up the side walls 561 of the cage cover 560. There is a “V-Cut” applied between the flat flaps 52 and the carrier for easy carrier strip break-off. After the carrier strip break-off, the remaining tab, flat flap 52, will become a pick and place landing pad, and then the flat flaps 52 be formed up, this can be done in a locating and bending fixture after carrier strip break-off. The pickup and place tool 61 offers accurate placement of the individual bunker 50 as they are distributed to the paddle card. The the pick and place landing pad offer adequate surface area for the nozzle of pickup and place tool 61 accommodation. Solder paste is applied to the ground pad of the paddle card before pick and place the bunker 50. The pick and place landing pad creates extra structure and support for bending and closing of the metal cage cover 560. After pick and place, the cage body 540 are reflow-soldered with the cage cover 50 in the open position to received the cable.

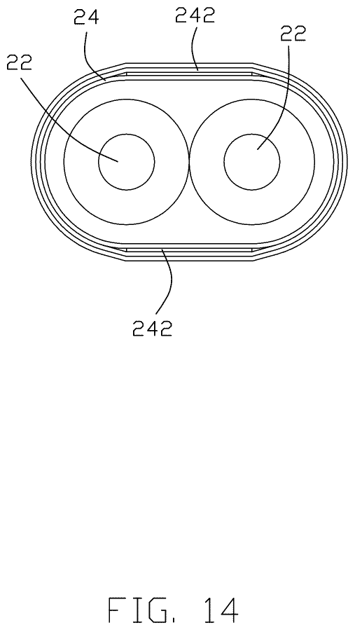

FIG. 14 shows a twin-ax cable with the two signal conductors 22 which is suitable for use in the cable card assembly 100 or 200. The cable is a 26 AWG or 28 AWG drainless twin-ax cable. The twin-ax cable may further include an upper and /r lower ground plates 242 placed upon or in contact with the ground shield 24, and mechanically and electrically connected to the bunker. The upper and lower ground plates 242 may then become part of the ground shield 242 which together constitute an overall ground shield.

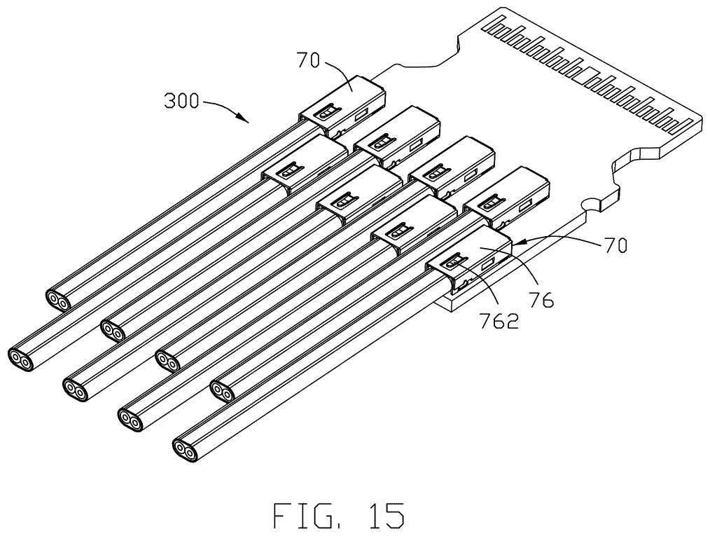

FIG. 15 shows another varied cable card assembly 300 in accordance with the present invention which differs from the assembly 200 primarily in that plural bunkers 70 thereof are each provided with a finger 762 on a top wall 76 thereof for engaging the ground shield of the cable rather than through a wire when cage is closed and latched.

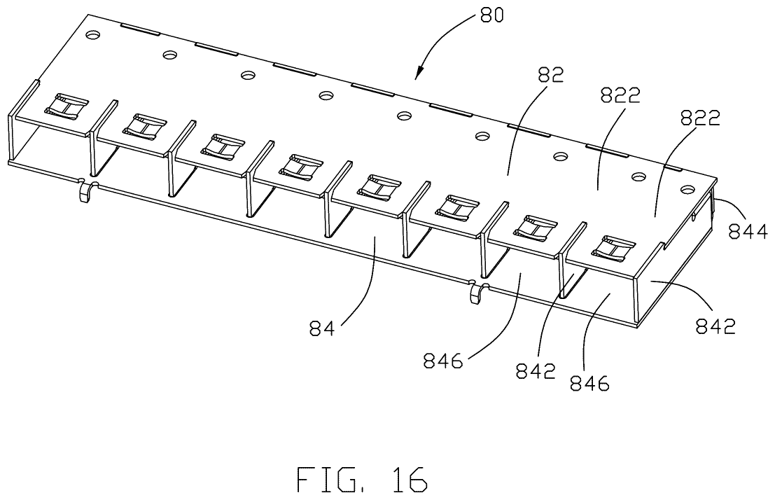

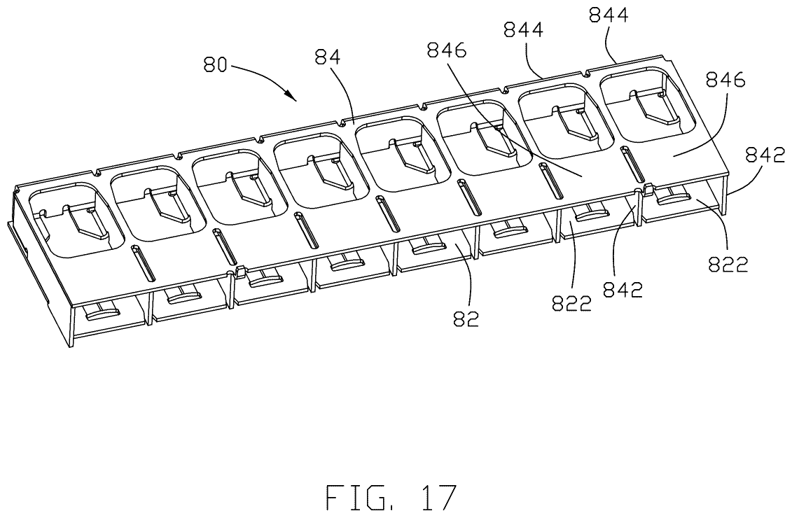

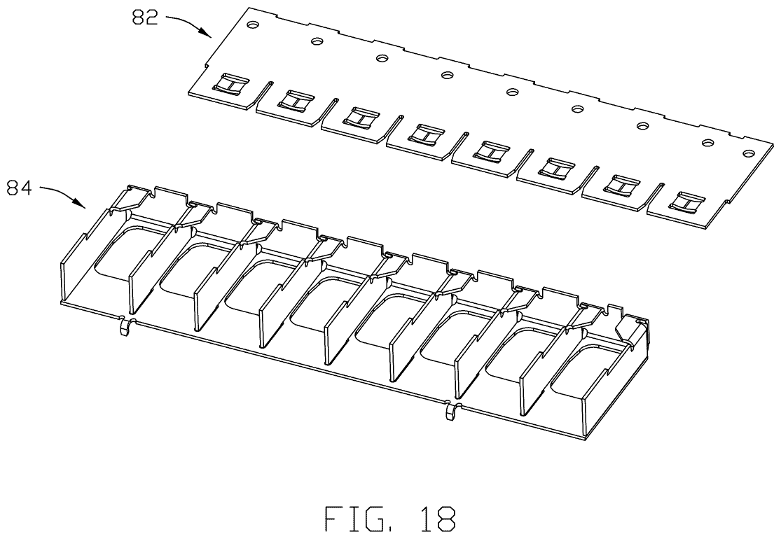

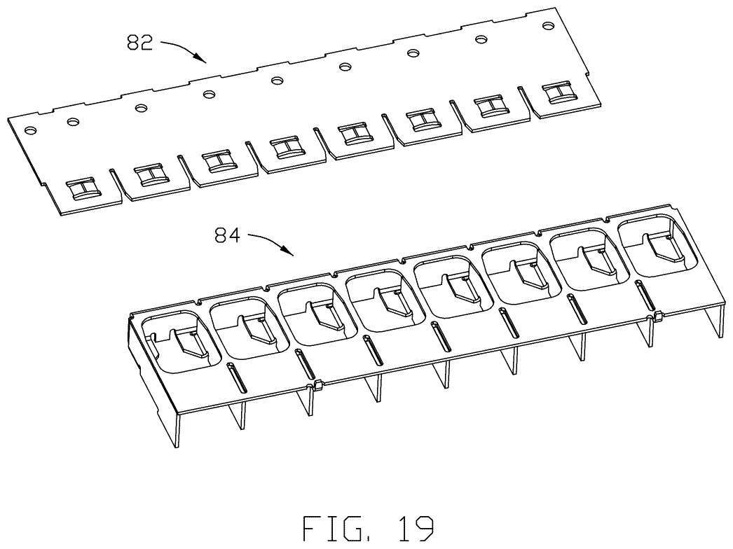

FIGS. 16-19 show another varied bunker structure 80 which may include a one-piece upper plate 82 serving as a cap to define top walls 822 of the bunkers and a one-piece lower plate 84 bent and formed to define respective side walls 842, rear walls 844, and bottom walls 846 of the bunkers. After the cables are guided by the side walls 842 into the bunkers 80 and soldered in place, the upper plate 82 may be suitably connected to the lower plate 84 by spot welding so that there is no gap between individual bunkers in order to achieve excellent crosstalk canceling. In this design, the bunkers 80 may be conveniently soldered onto the ground pads of the paddle card using automatic pickup and place reflow process. It is noted that in this design two adjacent bunkers 80 share a common sidewall 842, which is beneficial to space saving.

In the present invention, the development of mechanical attributes to improve the cable assembly and reduce cross-talk at these high data rates. The present invention focus on fine-pitch cable assembly, fixture design and fabrication. This present invention will describe a potential solution for reducing the cross-talk on the high-speed cable paddle card and cable termination areas. The cable card assembly of the present invention can transmit high-speed signals of 224 Gbps or above.

The cable card assembly of the present invention may conform to the specification of OSFP, which defines eight transmitting channels and eight receiving channels, and the signal transmission rate of each channel can reach 50 Gbps or above. The present invention can also be applied to high-speed electrical connector assembly such as SFP-DD, SFP, QSFP-DD, etc.

1. A cable card assembly comprising:
a paddle card having plural mating pads at a front end thereof, plural cable pads and ground pads at a rear end thereof;
plural cables terminated to the paddle card at the rear end, each cable having two signal conductors terminated to corresponding cable pads and a ground shield; and
plural bunkers terminated to corresponding ground pads, each bunker having a front opening, a bottom wall, a pair of side walls, a rear wall, and a top wall.

2. The cable card assembly as claimed in claim 1, wherein the cables are terminated on the paddle card in a single row.

3. The cable card assembly as claimed in claim 1, wherein the cables are terminated on the paddle card in a staggered fashion in a front and rear direction.

4. The cable card assembly as claimed in claim 1, wherein the cable is resistance welded or laser soldered to the paddle card.

5. The cable card assembly as claimed in claim 1, wherein the cable is a 26 AWG or 28 AWG drainless twin-ax cable.

6. The cable card assembly as claimed in claim 5, wherein the twin-ax cable further includes an upper ground plate or a lower ground plate placed upon or in contact with the ground shield and mechanically and electrically connected to the bunker.

7. The cable card assembly as claimed in claim 1, wherein the front mating pads are electrically connected through wiring traces in the paddle card to the rear cable pads and ground pads.

8. The cable card assembly as claimed in claim 1, wherein the bunkers is formed by stamping and bending from an unfolded flat blank of sheet metal.

9. The cable card assembly as claimed in claim 1, wherein the respective top walls of the plural bunkers are connected together by linking portions between the top walls of every two adjacent bunkers.

10. The cable card assembly as claimed in claim 9, wherein the linking portion has a feature for engaging the ground shield of the cable.

11. The cable card assembly as claimed in claim 1, wherein the top wall of the bunker has a feature for engaging the ground shield of the cable.

12. The cable card assembly as claimed in claim 11, wherein the feature includes an elastic finger abutting the ground shield of the cable.

13. The cable card assembly as claimed in claim 12, wherein solder is applied to the contact area of the feature and the ground shield.

14. The cable card assembly as claimed in claim 1, wherein the bunkers are installed on both sides of the paddle card, and are arranged in a belly to belly manner.

15. The cable card assembly as claimed in claim 1, wherein the plural bunkers are each separate and discrete.

16. The cable card assembly as claimed in claim 1, wherein each bunker includes a cage body and a cage cover, each of the cage cover and the cage body has a pair of side walls, the pair of side walls of the cage cover are located outside the pair of side wall of the cage body, and latching features are formed on the side walls of the cage body to assist in formation of the side wall and latch with the side walls of the cage cover.

17. The cable card assembly as claimed in claim 16, wherein a flat flap extends from the rear wall of the bunker for being operated by a pickup and place tool to place each individual bunker onto the paddle card.

18. The cable card assembly as claimed in claim 1, wherein a wire is provided for fitting into a respective cut formed on the side wall to engage the bunker to the ground shield of the cable.

19. The cable card assembly as claimed in claim 1, wherein the bunkers include a one-piece upper plate serving as a cap to define top walls of the bunkers and a one-piece lower plate bent and formed to define respective side walls, rear walls, and bottom walls of the bunkers, and two adjacent bunkers share a common sidewall.

20. The cable card assembly as claimed in claim 19, wherein the upper plate is connected to the lower plate by spot welding and there is no gap between individual bunkers.
